(19) United States
(12) Patent Application Publication
(10) Pub. No.: US 2024/0157645 A1
(43) Pub. Date: May 16, 2024

(54) PLASTICIZING DEVICE AND THREE-DIMENSIONAL MODELING DEVICE

(71) Applicant: SEIKO EPSON CORPORATION, Tokyo (JP)

(72) Inventors: Manabu WATANABE, SHIOJIRI-SHI (JP); Makoto OMURA, MATSUMOTO-SHI (JP)

(21) Appl. No.: 18/507,739

(22) Filed: Nov. 13, 2023

(30) Foreign Application Priority Data
Nov. 15, 2022 (JP) 2022-182342

(51) Int. Cl. B29C 64/321; B29C 64/393; B33Y 40/00

(52) U.S. Cl. CPC B29C 64/321; B29C 64/393; B33Y 40/00; B33Y 30/00

(57) ABSTRACT

A plasticizing device includes: a nozzle configured to extrude a modeling material; a drive motor; a screw configured to be rotated by the drive motor and including a groove formation surface in which a groove is formed; a barrel including a facing surface facing the groove formation surface and provided with a heater and a communication hole; a first heating unit configured to heat the modeling material supplied between the groove formed in the groove formation surface and the barrel; a second heating unit configured to heat the modeling material supplied to the nozzle; and a control unit configured to control the drive motor, the first heating unit, and the second heating unit. When the modeling material contains a crystalline resin, the control unit controls at least one of the first heating unit and the second heating unit to reduce a difference between a first temperature corresponding to a temperature of the barrel and a second temperature corresponding to a temperature of the nozzle.

The present application is based on, and claims priority from JP Application Serial Number 2022-182342, filed on Nov. 15, 2022, the disclosure of which is hereby incorporated by reference herein in its entirety.

### BACKGROUND

### 1. Technical Field

The present disclosure relates to a plasticizing device and a three-dimensional modeling device.

### 2. Related Art

Research and development have been conducted on a three-dimensional modeling device including a plasticizing device capable of plasticizing at least a part of a modeling material containing a thermoplastic resin and extruding the plasticized modeling material from a nozzle.

In this regard, there is known a three-dimensional modeling device including a plasticizing device capable of using a crystalline resin such as polyacetal (POM) and a non-crystalline resin such as acrylonitrile butadiene styrene (ABS) as thermoplastic resins (see JP-A-2020-059219).

Here, in the plasticizing device as disclosed in JP-A-2020-059219, it is known that a variation in an amount of a modeling material extruded from a nozzle per time unit lowers modeling accuracy of a three-dimensional modeled object modeled by the three-dimensional modeling device. Therefore, in the plasticizing device, an extrusion amount of the modeling material from the nozzle may be stabilized by increasing a temperature of the nozzle. However, a rate of change in viscosity of the plasticized crystalline resin with respect to a temperature change is larger than a rate of change in viscosity of the plasticized non-crystalline resin with respect to a temperature change. Therefore, a user cannot apply a modeling condition for reducing a variation in an extrusion amount per time unit of the modeling material containing the non-crystalline resin as a thermoplastic resin to a modeling condition for stabilizing an extrusion amount of the modeling material containing the crystalline resin as a thermoplastic resin. When the plasticizing device extrudes the modeling material containing the crystalline resin as the thermoplastic resin from the nozzle, the extrusion amount of the modeling material from the nozzle may not be stabilized by simply increasing the temperature of the nozzle. In other words, the plasticizing device cannot be applied under the modeling condition for stabilizing the extrusion amount of the modeling material containing the non-crystalline resin as the thermoplastic resin as the modeling condition for stabilizing the extrusion amount of the modeling material containing the crystalline resin as the thermoplastic resin.

### SUMMARY

According to an aspect of the disclosure, there is provided a plasticizing device including: a nozzle configured to extrude a modeling material; a drive motor; a screw configured to be rotated by the drive motor and including a groove formation surface in which a groove is formed; a barrel including a facing surface facing the groove formation surface and provided with a heater and a communication hole; a first heating unit configured to heat the modeling material supplied between the groove formed in the groove formation surface and the barrel; a second heating unit configured to heat the modeling material supplied to the nozzle; and a control unit configured to control the drive motor, the first heating unit, and the second heating unit. When the modeling material contains a crystalline resin, the control unit controls at least one of the first heating unit and the second heating unit to reduce a difference between a first temperature corresponding to a temperature of the barrel and a second temperature corresponding to a temperature of the nozzle.

According to another aspect of the disclosure, there is provided a three-dimensional modeling device including a plasticizing device. The plasticizing device includes: a nozzle configured to extrude a modeling material; a drive motor; a screw configured to be rotated by the drive motor and including a groove formation surface in which a groove is formed; a barrel including a facing surface facing the groove formation surface and provided with a heater and a communication hole; a first heating unit configured to heat the modeling material supplied between the groove formed in the groove formation surface and the barrel; a second heating unit configured to heat the modeling material supplied to the nozzle; and a control unit configured to control the drive motor, the first heating unit, and the second heating unit. When the modeling material contains a crystalline resin, the control unit controls at least one of the first heating unit and the second heating unit to reduce a difference between a first temperature corresponding to a temperature of the barrel and a second temperature corresponding to a temperature of the nozzle.

### BRIEF DESCRIPTION OF THE DRAWINGS

FIG. 1 is a diagram showing an example of a configuration of a three-dimensional modeling device 1.

FIG. 2 is a diagram showing an example of a hardware configuration of a control device 40.

FIG. 3 is a diagram showing an example of a functional configuration of the control device 40.

FIG. 4 is a diagram showing an example of a flow of processing of executing extrusion temperature adjustment control by the control device 40.

FIG. 5 is a diagram showing an example of a result of the extrusion temperature adjustment control executed by the control device 40.

FIG. 6 is a diagram showing an example of a flow of processing of executing a modification of the extrusion temperature adjustment control by the control device 40.

### DESCRIPTION OF EMBODIMENTS

### Embodiment

Hereinafter, an embodiment of the disclosure will be described with reference to the drawings.

### Overview of Three-Dimensional Modeling Device

First, an overview of a three-dimensional modeling device according to an embodiment will be described.

The three-dimensional modeling device according to the embodiment includes a plasticizing device according to the embodiment. The plasticizing device includes a nozzle, a drive motor, a screw, a barrel, a first heating unit, a second heating unit, and a control unit. The nozzle extrudes a modeling material. The screw is rotated by the drive motor and includes a groove formation surface in which grooves are formed. The barrel includes a facing surface facing the groove formation surface, and is provided with a heater and a communication hole. The first heating unit heats the modeling material supplied between the groove formed in the groove formation surface and the barrel. The second heating unit heats the modeling material supplied to the nozzle. The control unit controls each of the drive motor, the first heating unit, and the second heating unit. When the modeling material contains a crystalline resin, the control unit controls at least one of the first heating unit and the second heating unit to reduce a difference between a first temperature corresponding to a temperature of the barrel and a second temperature corresponding to a temperature of the nozzle. Accordingly, the three-dimensional modeling device and the plasticizing device can stabilize an extrusion amount of the modeling material containing the crystalline resin from the nozzle.

Hereinafter, a configuration of the three-dimensional modeling device according to the embodiment, a configuration of the plasticizing device according to the embodiment, and processing executed by the three-dimensional modeling device will be described in detail.

### Configuration of Three-Dimensional Modeling Device

Hereinafter, the configuration of the three-dimensional modeling device according to the embodiment will be described with a three-dimensional modeling device 1 as an example.

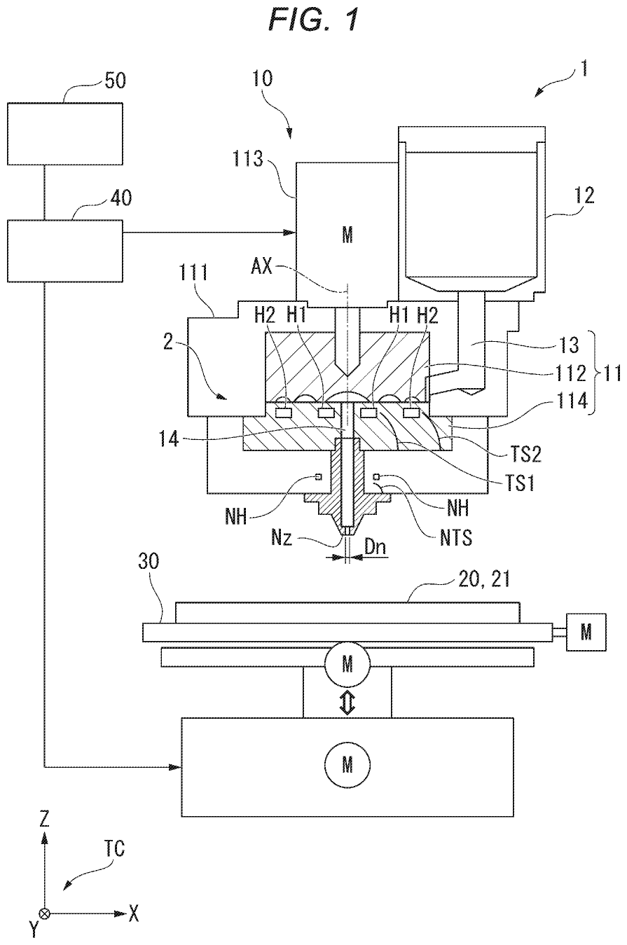

FIG. 1 is a diagram showing an example of a configuration of the three-dimensional modeling device 1.

Here, a three-dimensional coordinate system TC is a three-dimensional orthogonal coordinate system indicating directions in the drawings in which the three-dimensional coordinate system TC is drawn. Hereinafter, for convenience of description, an X axis in the three-dimensional coordinate system TC is simply referred to as the X axis. Hereinafter, for convenience of description, a Y axis in the three-dimensional coordinate system TC is simply referred to as the Y axis. Hereinafter, for convenience of description, a Z axis in the three-dimensional coordinate system TC is simply referred to as the Z axis. Hereinafter, a case where a negative direction of the Z axis coincides with a direction of gravity will be described as an example. Therefore, hereinafter, for convenience of description, a positive direction of the Z axis is referred to as an upper direction or simply as upward, and a negative direction of the Z axis is referred to as a lower direction or simply as downward.

The three-dimensional modeling device 1 includes an extrusion unit 10 including a plasticizing device 2 including a nozzle Nz, a stage 20 including a modeling surface 21 on which a three-dimensional modeled object is modeled, a movement unit 30, a control device 40, and a data generation device 50. In the three-dimensional modeling device 1, the data generation device 50 may be integrated with the control device 40. The three-dimensional modeling device 1 may not include the data generation device 50. In this case, the data generation device 50 is communicably connected to the three-dimensional modeling device 1 from the outside. The three-dimensional modeling device 1 may not include the control device 40 and the data generation device 50. In this case, the data generation device 50 is communicably connected to the three-dimensional modeling device 1 via the control device 40.

The three-dimensional modeling device 1 changes relative positions of the extrusion unit 10 and the stage 20 while extruding a modeling material X (not shown) from the extrusion unit 10 onto the modeling surface 21 of the stage 20. Accordingly, the three-dimensional modeling device 1 forms one three-dimensional modeled object having a predetermined shape by depositing N slice layers. Here, N may be any integer as long as N is an integer of 1 or more. In this case, a first slice layer counted from a bottom among the N slice layers is deposited on the modeling surface 21. Each of the N slice layers deposited on the modeling surface 21 is the modeling material X extruded along a modeling path parallel to the modeling surface 21. The modeling path is a scanning path of the nozzle Nz moving while extruding the modeling material X with respect to the stage 20. That is, the three-dimensional modeling device 1 extrudes the modeling material X by the extrusion unit 10 along a modeling path of an n-th slice layer among the N slice layers, and deposits the n-th slice layer on an (n−1)-th slice layer. Each of the N slice layers may include a single layer or a plurality of deposited layers. Here, n is an integer of 1 or more and N or less. A modeling path of a certain slice layer includes an outline that is a scanning path of the nozzle Nz along a contour of the slice layer and an infill that is a scanning path of the nozzle Nz in a region surrounded by the outline. That is, the certain slice layer includes the modeling material X extruded along the outline of the slice layer and the modeling material X extruded along the infill of the slice layer.

The three-dimensional modeling device 1 models such a three-dimensional modeled object based on three-dimensional modeling data. The three-dimensional modeling device 1 generates the three-dimensional modeling data according to a received operation. The three-dimensional modeling data is data for causing the three-dimensional modeling device 1 to deposit N slice layers as a three-dimensional modeled object having a predetermined shape. The three-dimensional modeling device 1 stores shape data indicating the shape. The shape data may be, for example, any data indicating the shape, such as stereolithography (STL) data. Based on the received operation and the shape data, the three-dimensional modeling device 1 generates object data indicating a virtual object including at least a modeled object, among a virtual modeled object having a shape indicated by the shape data and a virtual support added to the modeled object to support the modeled object. The modeled object is a portion separated from the N slice layers as one three-dimensional modeled object among portions of the deposited N slice layers. The support is a portion that supports the modeled object among the portions of the deposited N slice layers.

After generating the object data, the three-dimensional modeling device 1 stores the generated object data. After storing the object data, the three-dimensional modeling device 1 virtually slices the object indicated by the stored object data into N layers based on slice condition information. Each of the N layers obtained by virtually slicing the object by the three-dimensional modeling device 1 corresponds to a respective one of the N slice layers. Hereinafter, for convenience of description, an n-th layer among the N layers is referred to as a slice layer VLn, and an n-th slice layer among the N slice layers is referred to as a slice layer Ln. In this case, for example, a first slice layer VL1 corresponds to a first slice layer L1. Hereinafter, the first slice layer VL1 to an N-th slice layer VLN are simply referred to as slice layers VL unless it is necessary to distinguish therebetween. Hereinafter, for convenience of description, the first slice layer L1 to an N-th slice layer LN are simply referred to as slice layers L unless it is necessary to distinguish therebetween. Here, the slice condition information is information indicating a slice condition for virtually slicing the object indicated by the object data stored in the three-dimensional modeling device 1 into N slice layers VL. The slice condition information includes information such as information indicating N that is the number of N slice layers VL and information indicating a thickness of each of the N slice layers VL.

After virtually slicing the object, the three-dimensional modeling device 1 generates a modeling path of the slice layer VL for each of the sliced N slice layers VL based on modeling path generation condition information. The modeling path is a scanning path of the nozzle Nz moving while extruding the modeling material X with respect to the stage 20. Therefore, the modeling material X extruded along a modeling path of the n-th slice layer VLn is the actual slice layer Ln corresponding to the slice layer VLn.

Here, the n-th slice layer VLn is one of slice layers obtained by slicing at least one of the modeled object and the support included in the object. Therefore, the n-th slice layer VLn includes at least one of a portion obtained by slicing the modeled object and a portion obtained by slicing the support. That is, the n-th slice layer VLn includes at least one of a layer obtained by slicing the modeled object and a layer obtained by slicing the support. Then, the layer obtained by slicing the modeled object is classified into two types which are a first solid layer and a modeling layer. The first solid layer is a solid layer of the modeled object. The modeled object includes the first solid layer and the modeling layer deposited between the first solid layer and the first solid layer. That is, the modeled object is modeled by depositing the first solid layer and the modeling layer. The layer obtained by slicing the support is classified into three types which are a second solid layer, a support layer, and a raft layer. The second solid layer is a solid layer of the support. The raft layer is a base layer on which each of the first solid layer, the modeling layer, the second solid layer, and the support layer is deposited. The support includes the second solid layer, the support layer deposited between the second solid layer and the second solid layer, and the raft layer. That is, the support is modeled by depositing the second solid layer, the support layer, and the raft layer. For example, when a shape of a certain modeled object is a shape having an overhang, an overhang portion of a portion of the modeled object is supported by such a support. From the above, a type of the n-th slice layer VLn is classified according to the layer provided in the n-th slice layer VLn. For example, when the n-th slice layer VLn includes only the first solid layer, the type of the n-th slice layer VLn is the first solid layer. For example, when the n-th slice layer VLn includes the first solid layer and the second solid layer, the type of the n-th slice layer VLn is represented by a combination of a type of a layer obtained by slicing the modeled object among layers provided in the n-th slice layer VLn and a type of a layer obtained by slicing the support among the layers provided in the n-th slice layer VLn, that is, a combination of the first solid layer and the second solid layer. The type of the n-th slice layer VLn is also a type of the n-th slice layer Ln. Therefore, the three-dimensional modeling device 1 can identify the type of the n-th slice layer VLn and the type of the slice layer Ln based on the slice condition information.

After generating the modeling path of the slice layer VL for each of the N slice layers VL based on the modeling path generation condition information, the three-dimensional modeling device 1 generates three-dimensional modeling data including modeling path information indicating the modeling path for each of the generated N slice layers VL. Here, the modeling path generation condition information is information indicating a modeling path generation condition for generating the modeling path for each of the N slice layers VL. The modeling path generation condition information includes information such as information indicating a shape of the modeling path for each type of each of the N slice layers VL, information indicating a width of the modeling path for each type of each of the N slice layers VL, and information indicating a movement speed of the nozzle Nz when extruding the modeling material X along the modeling path for each type of each of the N slice layers VL. The modeling path information indicating a certain modeling path includes other information such as information indicating a width of the modeling path and information indicating a movement speed of the nozzle Nz when extruding the modeling material X along the modeling path.

In the three-dimensional modeling device 1, the slice condition information includes (n−1)-th slice layer type information indicating a type of the (n−1)-th slice layer VLn−1 among the N slice layers VL and n-th slice layer type information indicating a type of the n-th slice layer VLn deposited on the (n−1)-th slice layer VLn−1 among the N slice layers VL. In the three-dimensional modeling device 1, the modeling path generation condition information includes correspondence information including information in which the type of the (n−1)-th slice layer VLn−1, the type of the n-th slice layer VLn, and information indicating a condition for generating the modeling path of the n-th slice layer VLn are associated with each other. When generating the modeling path of the n-th slice layer VLn, the three-dimensional modeling device 1 generates the modeling path of the n-th slice layer VLn based on the correspondence information, the type of the (n−1)-th slice layer VLn−1, and the type of the n-th slice layer VLn. Accordingly, the three-dimensional modeling device 1 can generate the three-dimensional modeling data in which each of the raft layer and the support is easily removed from the modeled object without involving a sintering step.

Here, the slice layer L of the raft layer among the N slice layers L is a layer formed between the modeling surface 21 and another layer as a base of the slice layer L of the other layer, and is a layer filled with the modeling material X. The other layer is an individual slice layer L deposited on the raft layer among the N slice layers L, and specifically, a part or all of the first solid layer, the modeling layer, the second solid layer, and the support layer. When the other layer is deposited on the modeling surface 21 in a manner of being in contact with the modeling surface 21, the other layer may not be easily peeled off from the modeling surface 21. In this case, the other layer may not be fixed with high accuracy. In this case, residual stress may remain in the other layer. In order to solve these problems, a layer deposited between the other layer and the modeling surface 21 is the slice layer L of the raft layer. The slice layer L of each of the solid layer, the modeling layer, and the support layer are formed by an outline that is the modeling material X extruded along a contour of a predetermined outer shape and an infill that is the modeling material X extruded in a region surrounded by the outline. The slice layer L of the solid layer is a layer in which a region surrounded by the outline of the slice layer L of the solid layer is filled therein with the infill substantially without any gap. In other words, the slice layer L of the solid layer is a layer in which a filling rate of the infill in the region is 100%. The slice layer L of the first solid layer is one or more layers containing the modeling material X forming a surface of the modeled object. The slice layer L of the modeling layer is one or more layers containing the modeling material X forming the inside of the modeled object. The slice layer L of the second solid layer is one or more layers containing the modeling material X forming a surface of the support. In addition, the slice layer L of the modeling layer is a layer in which the infill is provided in a region surrounded by an outline of the modeling layer and a region not filled with the infill is present in the region. In other words, the slice layer L of the modeling layer is a layer in which a filling rate of the infill in the region is lower than 100%. The slice layer L of the modeling layer is one or more layers containing the modeling material X forming the inside of the modeled object. The slice layer L of the support layer is a layer in which the infill is provided in a region surrounded by an outline of the support layer and a region not filled with the infill is present in the region. In other words, the slice layer L of the support layer is a layer in which a filling rate of the infill in the region is lower than 100%. The slice layer Ln of the support layer is one or more layers containing the modeling material X forming the inside of the support.

When depositing the N slice layers L on the modeling surface 21 based on the three-dimensional modeling data generated as described above, the three-dimensional modeling device 1 models one three-dimensional modeled object by extruding each of the N slice layers L onto the modeling surface 21 by the extrusion unit 10 and depositing the N slice layers L, as the slice layers L of types represented by a part or all of the raft layer, the first solid layer, the modeling layer, the second solid layer, and the support layer. Accordingly, the three-dimensional modeling device 1 can model a modeled object, in which each of the raft layer and the support is easily removed, as a three-dimensional modeled object without involving a sintering step. In other words, accordingly, the three-dimensional modeling device 1 can model the modeled object, in which each of the raft layer and the support is easily removed, as the three-dimensional modeled object by depositing the modeling material X containing the thermoplastic resin.

The extrusion unit 10 is an extrusion device that extrudes the modeling material X onto the modeling surface 31. As described above, the extrusion unit 10 includes the plasticizing device 2 including the nozzle Nz.

The plasticizing device 2 includes, together with the nozzle Nz, a material melting unit 11 that melts one or more types of material to form the modeling material X, and a material supply unit 12. Here, in the plasticizing device 2, the material supply unit 12 and the material melting unit 11 are coupled by a supply path 13. The material melting unit 11 and the nozzle Nz are coupled by a communication hole 14. Therefore, the nozzle Nz communicates with the material melting unit 11. The nozzle Nz extrudes, from a tip end thereof, the modeling material X supplied from the material melting unit 11 through the communication hole 14.

Here, when depositing the n-th slice layer Ln on the (n−1)-th slice layer Ln−1, the three-dimensional modeling device 1 changes a width of the modeling material X extruded onto an upper surface of the (n−1)-th slice layer Ln−1 by changing a distance between the upper surface of the (n−1)-th slice layer Ln−1 and the tip end of the nozzle Nz. However, a maximum value of the width of the modeling material X extruded onto an upper surface of the n-th slice layer Ln by the three-dimensional modeling device 1 is an outer diameter of the tip end of the nozzle Nz. This is because when the distance between the upper surface of the (n−1)-th slice layer Ln−1 and the tip end of the nozzle Nz is shorter than an inner diameter Dn of the tip end of the nozzle Nz, the modeling material X extruded from the tip end of the nozzle Nz is extruded onto the upper surface of the (n−1)-th modeling layer while being crushed by the tip end of the nozzle Nz.

The material supply unit 12 accommodates one or more types of materials in a state of pellets, powder, or the like. Hereinafter, a case where the material accommodated in the material supply unit 12 is a pellet-shaped crystalline resin will be described as an example. Here, the crystalline resin usable in the plasticizing device 2 is a crystalline resin having a melting point lower than a temperature that can be set as a temperature in a first region or a second region to be described later. In the embodiment, the temperature that can be set as the temperature in the first region or the second region is a temperature within a range of approximately 160° C. to 210° C. In this case, the plasticizing device 2 can use, for example, polyacetal (POM) or polypropylene (PP) as such a crystalline resin. The temperature that can be set as the temperature in the first region or the second region varies depending on a configuration of the plasticizing device 2. Therefore, it is merely an example that the temperature that can be set as the temperature in the first region or the second region is within a range of approximately 160° C. to 210° C. Hereinafter, a case where the material accommodated in the material supply unit 12 is pellet-shaped POM will be described as an example. The material accommodated in the material supply unit 12 may include one or more other materials in addition to the pellet-shaped POM. The material accommodated in the material supply unit 12 may be a pellet-shaped non-crystalline resin instead of the pellet-shaped crystalline resin. That is, the plasticizing device 2 can extrude either the modeling material X containing the crystalline resin or the modeling material X containing the non-crystalline resin from the nozzle Nz by changing the material accommodated in the material supply unit 12. The plasticizing device 2 may include, as the material supply unit 12, both a first material supply unit that accommodates the pellet-shaped crystalline resin and a second material supply unit that accommodates the pellet-shaped non-crystalline resin. In this case, the plasticizing device 2 switches the material to be supplied to the supply path 13 provided below the material supply unit 12 between the pellet-shaped crystalline resin and the pellet-shaped non-crystalline resin in response to an operation from a user or a request from the control device 40. Examples of the pellet-shaped non-crystalline resin that can be accommodated in the material supply unit 12 include acrylonitrile butadiene styrene (ABS) and the like. The material supply unit 12 is implemented by, for example, a hopper. The material accommodated in the material supply unit 12 is supplied to the material melting unit 11 via the supply path 13 formed below the material supply unit 12.

The material melting unit 11 includes a screw case 111, a flat screw 112 accommodated in the screw case 111, a drive motor 113 that drives the flat screw 112, and a barrel 114 fixed below the flat screw 112 in the screw case 111.

The flat screw 112 is rotated by the drive motor 113 and includes a groove formation surface in which grooves are formed. More specifically, the flat screw 112 is a screw having a flat cylindrical shape, and a spiral groove portion extending from an outer periphery of a cylinder toward a central axis AX of the cylinder is formed in a bottom surface of the cylinder. This bottom surface is the groove formation surface of the flat screw 112. A structure of the flat screw 112 is described in detail in, for example, JP-A-2022-007237. Therefore, in the embodiment, further detailed description of the structure will be omitted.

The barrel 114 includes a facing surface facing the groove formation surface of the flat screw 112, and is provided with a first heater H1, a second heater H2, a first temperature detection unit TS1, a second temperature detection unit TS2, and the communication hole 14.

The first heater H1 and the second heater H2 are controlled by the control device 40. The first heater H1 and the second heater H2 heat, as the modeling material X, the material supplied via the supply path 13 between the grooves formed in the groove formation surface of the flat screw 112 and the barrel 114. The first heater H1 and the second heater H2 are, for example, electric heating wires, and may be other types of heaters instead.

By heating the first region in a region on the facing surface of the barrel 114, the first heater H1 heats the modeling material X supplied between the grooves formed in the groove formation surface of the flat screw 112 and the first region. Therefore, the first heater H1 is disposed in the first region. The first region is a region closer to the communication hole 14 than is the second region heated by the second heater H2 on the facing surface of the barrel 114. More specifically, the first region is a substantially circular region surrounded by the second region on the facing surface of the barrel 114, and is a region closer to a rotation axis of the groove formation surface of the flat screw 112 than is the second region. The first heater H1 is an example of a first heating unit. A first region temperature T1 is an example of a temperature of the barrel.

By heating the second region in the region on the facing surface of the barrel 114, the second heater H2 heats the modeling material X supplied between the grooves formed in the groove formation surface of the flat screw 112 and the second region. The second region is a region farther from the communication hole 14 than is the first region heated by the first heater H1 on the facing surface of the barrel 114. More specifically, the second region is a substantially ring-shaped region surrounding the first region on the facing surface of the barrel 114, and is a region farther from the rotation axis of the groove formation surface of the flat screw 112 than is the first region.

The first temperature detection unit TS1 is a temperature sensor that detects the first region temperature T1 corresponding to a temperature in the first region, and is, for example, a thermocouple. The first temperature detection unit TS1 may be another type of temperature sensor instead of the thermocouple. The first temperature detection unit TS1 outputs a signal corresponding to the detected temperature to the control device 40. The first region temperature T1 may be, for example, the temperature in the first region, a temperature of the first heater H1, or another temperature indicating the temperature in the first region. Hereinafter, a case where the first temperature detection unit TS1 detects the temperature of the first heater H1 as the first region temperature T1 will be described as an example. The first region temperature T1 is an example of a first temperature.

The second temperature detection unit TS2 is a temperature sensor that detects a second region temperature T2 corresponding to a temperature in the second region, and is, for example, a thermocouple. The second temperature detection unit TS2 may be another type of temperature sensor instead of the thermocouple. The second temperature detection unit TS2 outputs a signal corresponding to the detected temperature to the control device 40. The second region temperature T2 may be, for example, the temperature in the second region, a temperature of the second heater H2, or another temperature indicating the temperature in the second region. Hereinafter, a case where the second temperature detection unit TS2 detects the temperature of the second heater H2 as the second region temperature T2 will be described as an example.

The material supplied between the rotating flat screw 112 and the barrel 114 via the supply path 13 is melted at least in part by rotation of the flat screw 112 and the heating by a heater built in the barrel 114 to become the pasty modeling material X having fluidity. The modeling material X is supplied to the nozzle Nz via the communication hole 14 formed in the barrel 114 by the rotation of the flat screw 112. The modeling material X supplied to the nozzle Nz is extruded from the tip end of the nozzle Nz toward the stage 20.

The extrusion unit 10 further includes a nozzle heater NH and a nozzle temperature detection unit NTS between the barrel 114 and a flange of the nozzle Nz.

The nozzle heater NH heats the modeling material X supplied to the nozzle Nz by heating a position close to the nozzle Nz among positions between the barrel 114 and the flange of the nozzle Nz. The nozzle heater NH may heat the nozzle Nz instead of the position close to the nozzle Nz among the positions between the barrel 114 and the flange of the nozzle Nz, or may heat the nozzle Nz by heating another predetermined position with respect to the nozzle Nz. The nozzle heater NH is, for example, an electric heating wire, and may be another type of heater instead. The nozzle heater NH is an example of a second heating unit.

The third temperature detection unit TS3 is a temperature sensor that detects a nozzle temperature T3 corresponding to a temperature of the nozzle Nz, and is, for example, a thermocouple. The third temperature detection unit TS3 may be another type of temperature sensor instead of the thermocouple. The third temperature detection unit TS3 outputs a signal corresponding to the detected temperature to the control device 40. The nozzle temperature T3 may be, for example, the temperature of the nozzle Nz, a temperature of the nozzle heater NH, or another temperature indicating the temperature of the nozzle Nz. Hereinafter, a case where the third temperature detection unit TS3 detects the temperature of the nozzle heater NH as the nozzle temperature T3 will be described as an example. The nozzle temperature T3 is an example of a second temperature.

The movement unit 30 changes relative positions of the nozzle Nz of the extrusion unit 10 and the stage 20. More specifically, the movement unit 30 changes the relative positions of the nozzle Nz of the extrusion unit 10 and the stage 20 by moving one or both of the extrusion unit 10 and the stage 20. Hereinafter, a case where the relative positions of the nozzle Nz of the extrusion unit 10 and the stage 20 are changed by the movement unit 30 moving the stage 20 will be described as an example. For example, the movement unit 30 is implemented by a three-axis positioner that moves the stage 20 in directions parallel to the X axis, the Y axis, and the Z axis by driving forces of three motors. In this case, these three motors are controlled by the control device 40. Hereinafter, for convenience of description, a relative speed of the extrusion unit 10 with respect to the stage 20 is simply referred to as a movement speed.

The control device 40 controls the entire three-dimensional modeling device 1. The control device 40 acquires three-dimensional modeling data generated by the data generation device 50 via a network or a recording medium. The control device 40 executes a three-dimensional modeling program stored in advance to execute modeling control for controlling operations of the extrusion unit 10 and the movement unit 30 according to the three-dimensional modeling data, thereby modeling a three-dimensional modeled object. The control device 40 may not be implemented by a computer but by a combination of a plurality of circuits.

The modeling control is control over the extrusion unit 10 and the movement unit 30. Specifically, the modeling control is control for modeling one three-dimensional modeled object having a predetermined shape by depositing N slice layers L on the modeling surface 21. Here, the n-th slice layer Ln among the N slice layers L is deposited on the (n−1)-th slice layer Ln−1. At this time, when the n-th slice layer Ln is deposited on the (n−1)-th slice layer Ln, a part of the (n−1)-th slice layer Ln−1 is melted by heat of the n-th slice layer Ln. Therefore, the n-th slice layer Ln is joined to the (n−1)-th slice layer Ln−1. As a result, the N slice layers L are deposited on the modeling surface 21 as one three-dimensional modeled object. Therefore, in the embodiment, a 0th slice layer L0 means the modeling surface 21. That is, in the embodiment, the first slice layer L1 is deposited on the 0th slice layer L0, that is, the modeling surface 21.

When the n-th slice layer Ln is deposited on the (n−1)-th slice layer Ln−1, the control device 40 controls the extrusion unit 10 and the movement unit 30 to extrude the modeling material X along the modeling path of the n-th slice layer VLn corresponding to the n-th slice layer Ln by the extrusion unit 10. Accordingly, the control device 40 can deposit the n-th slice layer Ln on the (n−1)-th slice layer Ln−1. By executing the control as described above as the modeling control, the control device 40 sequentially extrudes the modeling material X, and models one three-dimensional modeled object by depositing N slice layers L on the modeling surface 21.

In the modeling control described above, when the modeling material X contains the crystalline resin, the control device 40 controls at least one of the first heater H1 and the nozzle heater NH to reduce a difference between the first region temperature T1 and the nozzle temperature T3. Accordingly, the control device 40 can reduce a temperature difference between a portion close to the first region among portions of the nozzle Nz and a portion close to the tip end of the nozzle Nz among the portions of the nozzle Nz. As a result, the control device 40 can keep viscosity of the modeling material X extruded through the nozzle Nz substantially constant in the nozzle Nz, and can stabilize an extrusion amount of the modeling material X containing the crystalline resin as the thermoplastic resin from the nozzle Nz. Among functions of the control device 40, when the modeling material X contains the crystalline resin, a part or all of functions of controlling at least one of the first heater H1 and the nozzle heater NH to reduce the difference between the first region temperature T1 and the nozzle temperature T3 may be provided in a control device separate from the control device 40. In this case, the control device may be integrated with the plasticizing device 2 or may be separate from the plasticizing device 2.

Here, the control device 40 is, for example, an information processing device such as a workstation, a desktop personal computer (PC), a notebook PC, a tablet PC, a multifunctional mobile phone terminal (smartphone), a mobile phone terminal, or a personal digital assistant (PDA), and is not limited thereto.

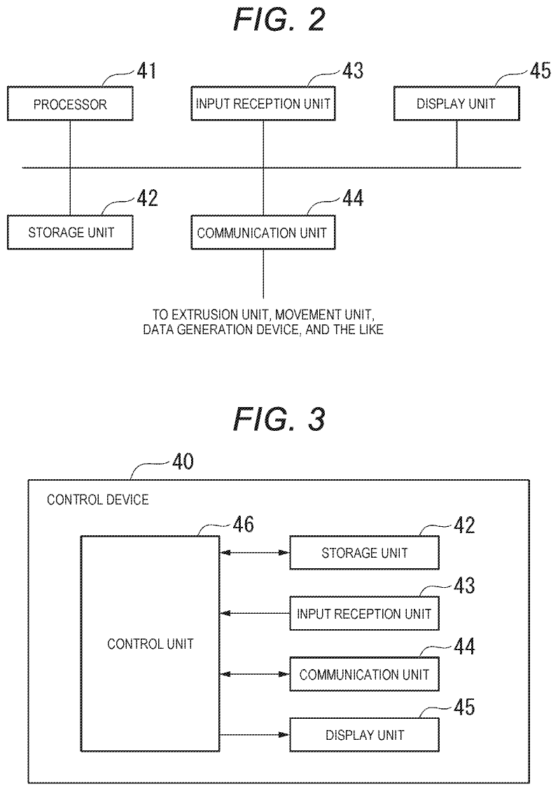

FIG. 2 is a diagram showing an example of a hardware configuration of the control device 40.

The control device 40 includes a processor 41, a storage unit 42, an input reception unit 43, a communication unit 44, and a display unit 45. As described above, the control device 40 may be an information processing device separate from the three-dimensional modeling device 1. In this case, the three-dimensional modeling device 1 is communicably connected to the information processing device and controlled by the information processing device.

The processor 41 is, for example, a central processing unit (CPU). The processor 41 may be another processor such as a field programmable gate array (FPGA). The processor 41 may include a plurality of processors. The processor 41 implements various functions of the control device 40 by executing various programs, various commands, and the like stored in the storage unit 42.

The storage unit 42 includes a hard disk drive (HDD), a solid state drive (SSD), an electrically erasable programmable read only memory (EEPROM), a read only memory (ROM), a random access memory (RAM), and the like. The storage unit 42 may be an external storage device coupled by a digital input and output port such as a universal serial bus (USB) instead of being built in the control device 40. The storage unit 42 stores various programs, various commands, various types of information, and the like to be processed by the control device 40. For example, the storage unit 42 stores the three-dimensional modeling data, the slice condition information, the modeling path generation condition information, the correspondence information, and the like.

The input reception unit 43 receives an operation from the user who performs the operation while viewing an image displayed on the display unit 45. The input reception unit 43 is an input device including, for example, a keyboard, a mouse, and a touch pad. The input reception unit 43 may be a touch panel integrated with the display unit 45.

The communication unit 44 includes, for example, a digital input and output port such as a USB, and an Ethernet (registered trademark) port.

The display unit 45 displays an image. As a display provided in the control device 40, the display unit 45 is a display device including, for example, a liquid crystal display panel, or an organic electro luminescence (EL) display panel.

FIG. 3 is a diagram showing an example of a functional configuration of the control device 40.

The control device 40 includes the storage unit 42, the input reception unit 43, the communication unit 44, the display unit 45, and a control unit 46.

The control unit 46 controls the entire three-dimensional modeling device 1. For example, the control unit 46 causes the three-dimensional modeling device 1 to model a three-dimensional modeled object by the modeling control described above. For example, in the modeling control, when the modeling material X contains a crystalline resin, the control unit 46 controls at least one of the first heater H1 and the nozzle heater NH to reduce a difference between the first region temperature T1 and the nozzle temperature T3. Hereinafter, for convenience of description, control for reducing the difference between the first region temperature T1 and the nozzle temperature T3 in this case is referred to as extrusion temperature adjustment control.

Functions of the control unit 46 are implemented by, for example, the processor 41 executing various programs stored in the storage unit 42. A part or all of the functions of the control unit 46 may be implemented as hardware functional units such as large scale integration (LSI) and an application specific integrated circuit (ASIC).

The data generation device 50 is a device that generates three-dimensional modeling data used by the three-dimensional modeling device 1 to model a three-dimensional modeled object. The data generation device 50 generates the three-dimensional modeling data by a method for generating the three-dimensional modeling data by the three-dimensional modeling device 1 described above. Therefore, description of the method will be omitted here. The data generation device 50 stores the shape data described above according to the received operation. The data generation device 50 may be or may not be capable of generating the shape data. When the data generation device 50 is not capable of generating the shape data, the data generation device 50 acquires the shape data from another device via a network or a storage medium. The data generation device 50 is implemented by a computer including one or more processors, a memory, and an input and output interface that receives signals from the outside and outputs signals to the outside.

### Processing of Executing Extrusion Temperature Adjustment Control by Control Device

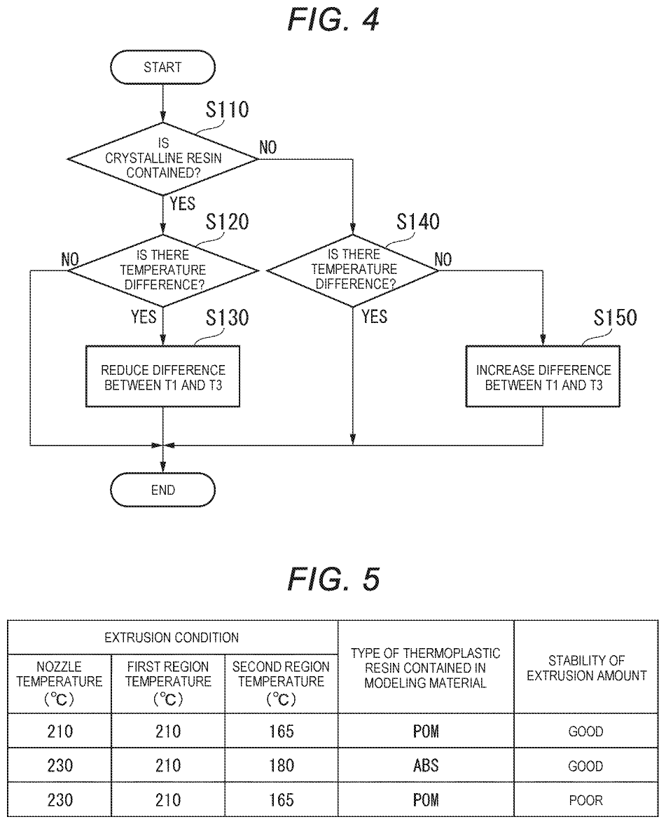

Hereinafter, processing of executing the extrusion temperature adjustment control by the control device 40 will be described with reference to FIG. 4. FIG. 4 is a diagram showing an example of a flow of processing of executing the extrusion temperature adjustment control by the control device 40. Hereinafter, a case will be described as an example, where the control device 40 receives an operation to start the modeling control at a timing before the processing in step S110 shown in FIG. 4 is executed. Hereinafter, a case will be described as an example, where the control device 40 receives modeling material information indicating which of the modeling material X containing a crystalline resin as a thermoplastic resin and the modeling material X containing a non-crystalline resin as a thermoplastic resin is to be extruded from the nozzle Nz at the timing. For example, the modeling material information is received by the control device 40 via an operation reception image displayed on the display unit 45. The operation reception image is an image for the control device 40 to receive an operation from the user, and is generated by the control unit 46. When the plasticizing device 2 and the material supply unit 12 are detachable from each other and the material supply unit 12 has the modeling material information as identification information capable of identifying a material accommodated in the material supply unit 12, the control device 40 may include a reading unit that reads the identification information and may receive the modeling material information on the material accommodated in the material supply unit 12 based on the identification information read by the reading unit. A timing at which the extrusion temperature adjustment control is started may be, for example, a timing at which the control device 40 receives an operation to start the modeling control, a timing at which the identification information is read by the reading unit in this case, or another timing before the modeling material X is extruded from the nozzle Nz. Hereinafter, a case will be described as an example, where the timing at which the extrusion temperature adjustment control is started is a timing at which the control device 40 receives the operation to start the modeling control.

After the control device 40 receives the operation to start the modeling control, the control unit 46 determines whether the modeling material X extruded from the nozzle Nz contains the crystalline resin based on the modeling material information received in advance (step S110). The control unit 46 may determine whether the modeling material X extruded from the nozzle Nz contains the crystalline resin by another method, instead of determining whether the modeling material X extruded from the nozzle Nz contains the crystalline resin based on the modeling material information in step S110.

When it is determined that the modeling material X extruded from the nozzle Nz contains the crystalline resin (YES in step S110), the control unit 46 identifies the first region temperature T1 based on a signal from the first temperature detection unit TS1 and identifies the nozzle temperature T3 based on a signal from the nozzle temperature detection unit NTS. Then, the control unit 46 determines whether there is a difference between the identified first region temperature T1 and the identified nozzle temperature T3 (step S120). Here, when the first region temperature T1 and the nozzle temperature T3 are away from each other by a predetermined threshold TH or more, the control unit 46 determines that there is a difference between the first region temperature T1 and the nozzle temperature T3. On the other hand, when the difference between the first region temperature T1 and the nozzle temperature T3 is not equal to or greater than the threshold TH, the control unit 46 determines that there is no difference between the first region temperature T1 and the nozzle temperature T3. The threshold TH is, for example, approximately 1° C., and may alternatively be a temperature lower than 1° C. or a temperature higher than 1° C.

When it is determined that there is no difference between the first region temperature T1 and the nozzle temperature T3 (NO in step S120), the control unit 46 ends the processing in a flowchart shown in FIG. 4, that is, the processing of executing the extrusion temperature adjustment control.

On the other hand, when it is determined that there is a difference between the first region temperature T1 and the nozzle temperature T3 (YES in step S120), the control unit 46 controls at least one of the first heater H1 and the nozzle heater NH to reduce the difference between the first region temperature T1 and the nozzle temperature T3 (step S130). Here, in step S130, the control unit 46 may bring the first region temperature T1 close to the nozzle temperature T3 by changing the first region temperature T1, bring the nozzle temperature T3 close to the first region temperature T1 by changing the nozzle temperature T3, or bring the first region temperature T1 and the nozzle temperature T3 close to each other by changing both the first region temperature T1 and the nozzle temperature T3. When the control unit 46 brings the first region temperature T1 and the nozzle temperature T3 close to each other by changing both the first region temperature T1 and the nozzle temperature T3, for example, both the first region temperature T1 and the nozzle temperature T3 are brought close to a predetermined target temperature. In this case, the control unit 46 receives information indicating the target temperature in advance via the operation reception image or the like. Here, the control unit 46 cannot set the first region temperature T1 to a temperature extremely away from the second region temperature T2. This is because the barrel 114 is formed of a single metal material. The outside of the barrel 114 is often cooled by cooling water. Therefore, the control unit 46 cannot increase the first region temperature T1 indefinitely. Under such circumstances, the control unit 46 can limit a decrease in a degree of freedom in design in the vicinity of the barrel 114 by changing the nozzle temperature T3 to bring the first region temperature T1 close to the nozzle temperature T3 in step S130. Under such circumstances, in the embodiment, a crystalline resin having a melting point lower than a temperature that can be set as a temperature in the first region or the second region is used as the crystalline resin contained in the modeling material X. By the processing in step S130, the control unit 46 can reduce a temperature difference between a portion close to the first region among portions of the nozzle Nz and a portion close to the tip end of the nozzle Nz among the portions of the nozzle Nz. As a result, the control unit 46 can keep viscosity of the modeling material X extruded through the nozzle Nz substantially constant in the nozzle Nz, and can stabilize an extrusion amount of the modeling material X containing the crystalline resin as the thermoplastic resin from the nozzle Nz. In other words, the control unit 46 can make a plasticized state of the modeling material X in a flow path from the flat screw 112 to the tip end of the nozzle Nz uniform by reducing the difference between the first region temperature T1 and the nozzle temperature T3, and can stabilize the extrusion amount of the modeling material X containing the crystalline resin as the thermoplastic resin from the nozzle Nz. This is because an attenuation rate at which a pressure generated by the flat screw 112 is attenuated until the pressure is transmitted from the vicinity of the flat screw 112 to the vicinity of the tip end of the nozzle Nz can be constant. After executing the processing in step S130, the control unit 46 ends the processing in the flowchart shown in FIG. 4, that is, the processing of executing the extrusion temperature adjustment control.

On the other hand, when the control unit 46 determines that the modeling material X extruded from the nozzle Nz does not contain the crystalline resin (NO in step S110), the control unit 46 determines that the modeling material X extruded from the nozzle Nz contains the non-crystalline resin. Thereafter, the control unit 46 identifies the first region temperature T1 based on a signal from the first temperature detection unit TS1, and identifies the nozzle temperature T3 based on a signal from the nozzle temperature detection unit NTS. Then, the control unit 46 determines whether there is a difference between the identified first region temperature T1 and the identified nozzle temperature T3 (step S140). The processing in step S140 is the same as the processing in step S120. Therefore, in the embodiment, detailed description of the processing in step S140 will be omitted.

When it is determined that there is a difference between the first region temperature T1 and the nozzle temperature T3 (YES in step S140), the control unit 46 ends the processing in the flowchart shown in FIG. 4, that is, the processing of executing the extrusion temperature adjustment control.

On the other hand, when it is determined that there is no difference between the first region temperature T1 and the nozzle temperature T3 (NO in step S140), the control unit 46 controls at least one of the first heater H1 and the nozzle heater NH to increase the difference between the first region temperature T1 and the nozzle temperature T3 (step S150). Here, in step S150, the control unit 46 may bring the first region temperature T1 away from the nozzle temperature T3 by changing the first region temperature T1, bring the nozzle temperature T3 away from the first region temperature T1 by changing the nozzle temperature T3, or bring the first region temperature T1 and the nozzle temperature T3 away from each other by changing both the first region temperature T1 and the nozzle temperature T3. When the control unit 46 brings the first region temperature T1 and the nozzle temperature T3 away from each other by changing both the first region temperature T1 and the nozzle temperature T3, for example, the control unit 46 brings the nozzle temperature T3 close to a second target temperature higher than a predetermined first target temperature while bringing the first region temperature T1 close to the first target temperature. In this case, the control unit 46 receives information indicating the first target temperature and information indicating the second target temperature in advance via the operation reception image or the like. Here, as described above, the control unit 46 cannot set the first region temperature T1 to a temperature extremely away from the second region temperature T2. Therefore, in step S150, the control unit 46 can limit a decrease in the degree of freedom in design in the vicinity of the barrel 114 by changing the nozzle temperature T3 to bring the nozzle temperature T3 away from the first region temperature T1. By the processing in step S150, the control unit 46 can make the temperature of the nozzle Nz higher than the first region temperature T1. As a result, the control unit 46 can stabilize an extrusion amount of the modeling material X containing the non-crystalline resin as the thermoplastic resin from the nozzle Nz. After executing the processing in step S150, the control unit 46 ends the processing in the flowchart shown in FIG. 4, that is, the processing of executing the extrusion temperature adjustment control.

According to the processing described above, the control device 40 executes the extrusion temperature adjustment control. That is, when the modeling material X contains the crystalline resin, the control device 40 controls at least one of the first heater H1 and the nozzle heater NH to reduce the difference between the first region temperature T1 and the nozzle temperature T3. Accordingly, the control device 40 can stabilize the extrusion amount of the modeling material containing the crystalline resin from the nozzle Nz.

### Result of Extrusion Temperature Adjustment Control by Control Device

Hereinafter, a result of the extrusion temperature adjustment control executed by the control device 40 will be described with reference to FIG. 5. FIG. 5 is a diagram showing an example of the result of the extrusion temperature adjustment control executed by the control device 40. A table shown in FIG. 5 shows a result of extrusion inspection in which, when the nozzle temperature T3 is 210° C., the first region temperature T1 is 210° C., and the second region temperature T2 is 165° C. under the extrusion temperature adjustment control, the control device 40 inspects whether the three-dimensional modeling device 1 can stably extrude the modeling material X containing POM as a thermoplastic resin from the nozzle Nz. In order to attain this result, the applicant performed the extrusion inspection nine times using the three-dimensional modeling device 1 in which an inner diameter Dn of the tip end of the nozzle Nz was set to 0.5 [mm], the number of rotations of the flat screw 112 was set to 4000 [rpm], and extrusion time of the modeling material X from the nozzle Nz was set to 1 minute. Then, the applicant measured a weight of the modeling material X extruded from the nozzle Nz in each of the nine times of extrusion inspection, and determined that an extrusion amount of the modeling material X from the nozzle Nz was stable when a standard deviation of the measured weight was 10% or less of an average value of the measured weights. As shown in FIG. 5, in this case, the three-dimensional modeling device 1 was able to stably extrude the modeling material X containing POM as the thermoplastic resin from the nozzle Nz. Therefore, “good” is described in a field indicating the stability in the table. From this result, it is understood that when the modeling material X contains POM, the control device 40 or the three-dimensional modeling device 1 can stabilize the extrusion amount of the modeling material X containing POM from the nozzle Nz by controlling at least one of the first heater H1 and the nozzle heater NH to reduce a difference between the first region temperature T1 and the nozzle temperature T3.

Here, FIG. 5 further shows results of two extrusion inspections as comparison targets for such a result. One of the two extrusion inspections is a result of extrusion inspection in which, when the nozzle temperature T3 is 230° C., the first region temperature T1 is 210° C., and the second region temperature T2 is 180° C., the control device 40 inspects whether the three-dimensional modeling device 1 can stably extrude the modeling material X containing ABS as a thermoplastic resin from the nozzle Nz. In order to obtain this result, the applicant performed the extrusion inspection nine times using the three-dimensional modeling device 1 in which an inner diameter Dn of the tip end of the nozzle Nz was set to 0.5 [mm], the number of rotations of the flat screw 112 was set to 4000 [rpm], and extrusion time of the modeling material X from the nozzle Nz was set to 1 minute. Then, the applicant measured a weight of the modeling material X extruded from the nozzle Nz in each of the nine times of extrusion inspection, and determined that an extrusion amount of the modeling material X from the nozzle Nz was stable when a standard deviation of the measured weight was 10% or less of an average value of the measured weights. As shown in FIG. 5, in this case, the three-dimensional modeling device 1 was able to stably extrude the modeling material X containing ABS as the thermoplastic resin from the nozzle Nz. Therefore, “good” is described in the field indicating the stability in the table. From this result, it is understood that when the modeling material X contains ABS, the control device 40 or the three-dimensional modeling device 1 can stabilize an extrusion amount of the modeling material X containing ABS from the nozzle Nz by controlling at least one of the first heater H1 and the nozzle heater NH to increase a difference between the first region temperature T1 and the nozzle temperature T3.

The other of the two extrusion inspections is a result of extrusion inspection in which, when the nozzle temperature T3 is 230° C., the first region temperature T1 is 210° C., and the second region temperature T2 is 165° C., the control device 40 inspects whether the three-dimensional modeling device 1 can stably extrude the modeling material X containing POM as a thermoplastic resin from the nozzle Nz. In order to obtain this result, the applicant performed the extrusion inspection nine times using the three-dimensional modeling device 1 in which an inner diameter Dn of the tip end of the nozzle Nz was set to 0.5 [mm], the number of rotations of the flat screw 112 was set to 4000 [rpm], and extrusion time of the modeling material X from the nozzle Nz was set to 1 minute. Then, the applicant measured a weight of the modeling material X extruded from the nozzle Nz in each of the nine times of extrusion inspection, and determined that an extrusion amount of the modeling material X from the nozzle Nz was stable when a standard deviation of the measured weight was 10% or less of an average value of the measured weights. As shown in FIG. 5, in this case, the three-dimensional modeling device 1 was not able to stably extrude the modeling material X containing POM as the thermoplastic resin from the nozzle Nz. Therefore, “poor” is described in the field indicating the stability in the table. From this result, it is understood that when the modeling material X contains ABS, the control device 40 or the three-dimensional modeling device 1 controls at least one of the first heater H1 and the nozzle heater NH to increase a difference between the first region temperature T1 and the nozzle temperature T3, making an extrusion amount of the modeling material X containing POM from the nozzle Nz unstable.

As described above, results of three extrusion inspections shown in FIG. 5 indicate that an extrusion condition for stabilizing an extrusion amount of the modeling material X containing a crystalline resin such as POM from the nozzle Nz is different from an extrusion condition for stabilizing an extrusion amount of the modeling material X containing a non-crystalline resin such as ABS from the nozzle Nz. That is, the extrusion temperature adjustment control executed by the control device 40 is useful for stabilizing the extrusion amount of the modeling material X containing the crystalline resin from the nozzle Nz.

### Modification of Extrusion Temperature Adjustment Control

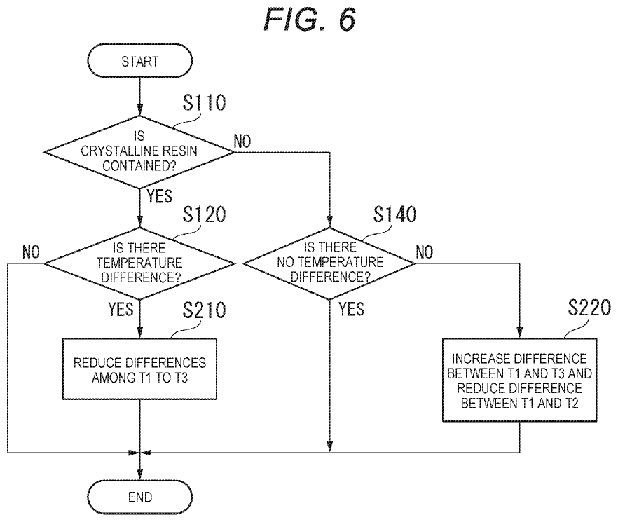

The control device 40 may execute the extrusion temperature adjustment control by the processing in a flowchart shown in FIG. 6 instead of the processing in the flowchart shown in FIG. 4. FIG. 6 is a diagram showing an example of a flow of processing of executing a modification of the extrusion temperature adjustment control by the control device 40. The processing in step S110 shown in FIG. 6 is the same as the processing in step S110 shown in FIG. 4. Therefore, in the embodiment, detailed description of the processing in step S110 shown in FIG. 6 will be omitted. The processing in step S120 shown in FIG. 6 is the same as the processing in step S120 shown in FIG. 4. Therefore, in the embodiment, detailed description of the processing in step S120 shown in FIG. 6 will be omitted. The processing in step S140 shown in FIG. 6 is the same as the processing in step S140 shown in FIG. 4. Therefore, in the embodiment, detailed description of the processing in step S140 shown in FIG. 6 will be omitted. Hereinafter, a case will be described as an example, where the control device 40 receives an operation to start the modeling control at a timing before the processing in step S110 shown in FIG. 6 is executed. Hereinafter, a case will be described as an example, where the control device 40 receives modeling material information indicating which of the modeling material X containing a crystalline resin as a thermoplastic resin and the modeling material X containing a non-crystalline resin as a thermoplastic resin is to be extruded from the nozzle Nz at the timing. Hereinafter, a case will be described as an example, where the timing at which the extrusion temperature adjustment control is started is a timing at which the control device 40 receives the operation to start the modeling control.

When it is determined that there is a difference between the first region temperature T1 and the nozzle temperature T3 in step S120 shown in FIG. 6, the control unit 46 controls at least one of the first heater H1, the second heater H2, and the nozzle heater NH to reduce differences among the first region temperature T1, the second region temperature T2, and the nozzle temperature T3 (step S210). Here, reducing the differences among the first region temperature T1, the second region temperature T2, and the nozzle temperature T3 means reducing both a difference between the first region temperature T1 and the second region temperature T2 and a difference between the second region temperature T2 and the nozzle temperature T3. In step S210, the control unit 46 may bring one or both of the first region temperature T1 and the second region temperature T2 close to the nozzle temperature T3, bring one or both of the first region temperature T1 and the nozzle temperature T3 close to the second region temperature T2, bring one or both of the second region temperature T2 and the nozzle temperature T3 close to the first region temperature T1, bring all of the first region temperature T1, the second region temperature T2, and the nozzle temperature T3 close to the target temperature described above, or reduce the differences among the first region temperature T1, the second region temperature T2, and the nozzle temperature T3 by another method. As described above, the outside of the barrel 114 is often cooled by the cooling water. Therefore, the control unit 46 cannot increase the first region temperature T1 indefinitely. Under such circumstances, the control unit 46 can limit a decrease in a degree of freedom in design in the vicinity of the barrel 114 by bringing both the first region temperature T1 and the nozzle temperature T3 close to the second region temperature T2 in step S210. By the processing in step S210, the control unit 46 can reduce a temperature difference between a portion close to the first region among portions of the nozzle Nz and a portion close to the tip end of the nozzle Nz among the portions of the nozzle Nz, and can reduce a temperature difference between the first region and the second region. As a result, the control unit 46 can stabilize an extrusion amount of the modeling material X containing the crystalline resin as the thermoplastic resin from the nozzle Nz, and can prevent occurrence of a bridging phenomenon between the groove formation surface of the flat screw 112 and the barrel 114. After executing the processing in step S210, the control unit 46 ends the processing in the flowchart shown in FIG. 6, that is, the processing of executing the extrusion temperature adjustment control.

When it is determined in step S140 shown in FIG. 6 that there is no difference between the first region temperature T1 and the nozzle temperature T3, the control unit 46 controls at least one of the first heater H1, the second heater H2, and the nozzle heater NH, increases the difference between the first region temperature T1 and the nozzle temperature T3, and reduces the difference between the first region temperature T1 and the second region temperature T2 (step S220). Here, the control unit 46 may increase the difference between the first region temperature T1 and the nozzle temperature T3 and reduce the difference between the first region temperature T1 and the second region temperature T2 by bringing the nozzle temperature T3 away from the first region temperature T1 and bringing the first region temperature T1 close to the second region temperature T2 in step S210. The control unit 46 may increase the difference between the first region temperature T1 and the nozzle temperature T3 and reduce the difference between the first region temperature T1 and the second region temperature T2 by bringing the first region temperature T1 close to the second region temperature T2. Further, the control unit 46 may increase the difference between the first region temperature T1 and the nozzle temperature T3 and reduce the difference between the first region temperature T1 and the second region temperature T2 by another method. By the processing in step S220, the control unit 46 can increase a temperature difference between a portion close to the first region among the portions of the nozzle Nz and a portion close to the tip end of the nozzle Nz among the portions of the nozzle Nz, and can reduce a temperature difference between the first region and the second region. As a result, the control unit 46 can stabilize an extrusion amount of the modeling material X containing the non-crystalline resin as the thermoplastic resin from the nozzle Nz, and can prevent occurrence of a bridging phenomenon between the groove formation surface of the flat screw 112 and the barrel 114. After executing the processing in step S220, the control unit 46 ends the processing in the flowchart shown in FIG. 6, that is, the processing of executing the extrusion temperature adjustment control.

The contents described above may be combined in any manner.

As described above, the plasticizing device 2 according to the embodiment includes: the nozzle Nz that extrudes the modeling material X; the drive motor 113; the flat screw 112 that is rotated by the drive motor 113 and includes a groove formation surface in which grooves are formed; the barrel 114 that includes a facing surface facing the groove formation surface and is provided with the first heater H1, the second heater H2, and the communication hole 14; the first heater H1 that heats the modeling material X supplied between the grooves formed in the groove formation surface and the barrel 114; the nozzle heater NH that heats the modeling material X supplied to the nozzle Nz; and the control unit 46 that controls each of the drive motor 113, the first heater H1, and the nozzle heater NH. When the modeling material X contains a crystalline resin, the control unit 46 controls at least one of the first heater H1 and the nozzle heater NH to reduce a difference between the first region temperature T1 and the nozzle temperature T3. Accordingly, the plasticizing device 2 can stabilize an extrusion amount of the modeling material X containing the crystalline resin from the nozzle Nz.

### APPENDIX

[1] A plasticizing device includes:
a nozzle configured to extrude a modeling material;
a drive motor;
a screw configured to be rotated by the drive motor and including a groove formation surface in which a groove is formed;
a barrel including a facing surface facing the groove formation surface and provided with a heater and a communication hole;
a first heating unit configured to heat the modeling material supplied between the groove formed in the groove formation surface and the barrel;
a second heating unit configured to heat the modeling material supplied to the nozzle; and
a control unit configured to control the drive motor, the first heating unit, and the second heating unit.

When the modeling material contains a crystalline resin, the control unit controls at least one of the first heating unit and the second heating unit to reduce a difference between a first temperature corresponding to a temperature of the barrel and a second temperature corresponding to a temperature of the nozzle.
[2] In the plasticizing device according to [1],
the first temperature is a temperature of the barrel, and
the second temperature is a temperature of the nozzle.
[3] In the plasticizing device according to [2],
the facing surface has a first region and a second region farther from the communication hole than is the first region, and
the temperature of the barrel is a temperature in the first region.
[4] In the plasticizing device according to [1],
the first temperature is a temperature of the first heating unit, and
the second temperature is a temperature of the second heating unit.
[5] In the plasticizing device according to [4],
the facing surface has a first region and a second region farther from the communication hole than is the first region, and
the first heating unit is disposed in the first region.
[6] In a three-dimensional modeling device including a plasticizing device,
the plasticizing device includes:
   a nozzle configured to extrude a modeling material;
   a drive motor;
   a screw configured to be rotated by the drive motor and including a groove formation surface in which a groove is formed;
   a barrel including a facing surface facing the groove formation surface and provided with a heater and a communication hole;
   a first heating unit configured to heat the modeling material supplied between the groove formed in the groove formation surface and the barrel;
   a second heating unit configured to heat the modeling material supplied to the nozzle; and
   a control unit configured to control the drive motor, the first heating unit, and the second heating unit.

When the modeling material contains a crystalline resin, the control unit controls at least one of the first heating unit and the second heating unit to reduce a difference between a first temperature corresponding to a temperature of the barrel and a second temperature corresponding to a temperature of the nozzle.

Although the embodiment of the disclosure has been described in detail with reference to the drawings, a specific configuration is not limited to the embodiment, and may be changed, replaced, deleted, or the like without departing from the scope of the disclosure.

A program for implementing a function of any component in a device described above may be recorded in a computer-readable recording medium, and the program may be read and executed by a computer system. Here, the device is, for example, the three-dimensional modeling device 1, the plasticizing device 2, the control device 40, the data generation device 50, or the like. Here, the “computer system” includes hardware such as an operating system (OS) or a peripheral device. The “computer-readable recording medium” refers to a portable medium such as a flexible disk, a magneto-optical disk, a ROM, or a compact disk (CD)-ROM, or a storage device such as a hard disk built into in a computer system. Further, the “computer-readable recording medium” includes a medium that holds a program for a certain period of time, such as a volatile memory inside a computer system serving as a server or a client when the program is transmitted via a network such as the Internet or a communication line such as a telephone line.

The program may be transmitted from a computer system in which the program is stored in a storage device or the like to another computer system via a transmission medium or through a transmission wave in the transmission medium. Here, the “transmission medium” that transmits the program refers to a medium having a function of transmitting information such as a network such as the Internet or a communication line such as a telephone line.

The program may be for implementing a part of the function described above. Further, the program may be a so-called differential file or a differential program capable of implementing the function described above in combination with a program already recorded in the computer system.

What is claimed is:

1. A plasticizing device comprising:
a nozzle configured to extrude a modeling material;
a drive motor;
a screw configured to be rotated by the drive motor and including a groove formation surface in which a groove is formed;
a barrel including a facing surface facing the groove formation surface and provided with a heater and a communication hole;
a first heating unit configured to heat the modeling material supplied between the groove formed in the groove formation surface and the barrel;
a second heating unit configured to heat the modeling material supplied to the nozzle; and
a control unit configured to control the drive motor, the first heating unit, and the second heating unit, wherein
when the modeling material contains a crystalline resin, the control unit controls at least one of the first heating unit and the second heating unit to reduce a difference between a first temperature corresponding to a temperature of the barrel and a second temperature corresponding to a temperature of the nozzle.

2. The plasticizing device according to claim 1, wherein
the first temperature is a temperature of the barrel, and
the second temperature is a temperature of the nozzle.

3. The plasticizing device according to claim 2, wherein
the facing surface has a first region and a second region farther from the communication hole than is the first region, and
the temperature of the barrel is a temperature in the first region.

4. The plasticizing device according to claim 1, wherein
the first temperature is a temperature of the first heating unit, and
the second temperature is a temperature of the second heating unit.

5. The plasticizing device according to claim 4, wherein
the facing surface has a first region and a second region farther from the communication hole than is the first region, and
the first heating unit is disposed in the first region.

6. A three-dimensional modeling device comprising:
a plasticizing device, wherein
the plasticizing device includes
a nozzle configured to extrude a modeling material,
a drive motor,
a screw configured to be rotated by the drive motor and including a groove formation surface in which a groove is formed,
a barrel including a facing surface facing the groove formation surface and provided with a heater and a communication hole,
a first heating unit configured to heat the modeling material supplied between the groove formed in the groove formation surface and the barrel,
a second heating unit configured to heat the modeling material supplied to the nozzle, and
a control unit configured to control the drive motor, the first heating unit, and the second heating unit, and
when the modeling material contains a crystalline resin, the control unit controls at least one of the first heating unit and the second heating unit to reduce a difference between a first temperature corresponding to a temperature of the barrel and a second temperature corresponding to a temperature of the nozzle.
